(19) United States
(12) Patent Application Publication
(10) Pub. No.: US 2023/0348700 A1
(43) Pub. Date: Nov. 2, 2023

(54) FLAME-RETARDANT RESIN COMPOSITION, MANUFACTURING METHOD OF SAME, FLAME-RETARDANT RESIN MOLDED PRODUCT, AND FLAME-RETARDANT RESIN HOUSING

(71) Applicant: Konica Minolta, Inc., Tokyo (JP)

(72) Inventors: Shinichi HAMAGUCHI, Hino-shi (JP); Kosuke NAKAMURA, Hachioji-shi (JP); Tomoo SAKIMURA, Hino-shi (JP)

(21) Appl. No.: 18/299,147

(22) Filed: Apr. 12, 2023

(30) Foreign Application Priority Data
Apr. 28, 2022 (JP) 2022-074207

(51) Int. Cl. C08L 5/08; C08L 55/02

(52) U.S. Cl. CPC C08L 5/08; C08L 55/02; C08L 2201/02; C08L 2203/30; C08L 2205/22

(57) ABSTRACT

An object of the present invention is to provide a flame-retardant-resin composition with improved flame resistance and impact resistance, a manufacturing method thereof, flame-retardant resin molded products, and a flame-retardant resin housing. The flame-retardant-resin composition of the present invention comprises a resin and a polysaccharide, wherein a sugar backbone in the polysaccharide has at least a basic functional group or a salt of the basic functional group. The flame-retardant resin composition of the present invention comprises a resin and a polysaccharide, wherein a sugar backbone in the polysaccharide has at least a basic functional group or a salt of the basic functional group.

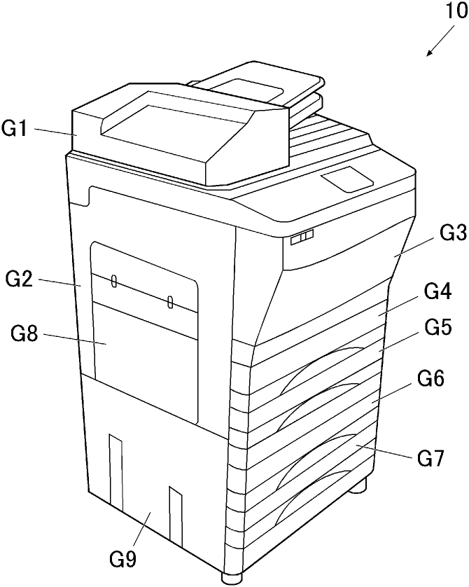

### REFERENCE TO RELATED APPLICATIONS

The entire disclosure of Japanese Patent Application No. 2022-074207, filed on Apr. 28, 2022, including description, claims, drawings and abstract is incorporated herein by reference in its entirety.

### TECHNICAL FIELD

The present invention relates to a flame-retardant resin composition and its manufacturing method, a flame-retardant resin molded product, and a flame-retardant resin housing. More particularly, the present invention relates to flame-retardant resin compositions with improved flame-retardancy and impact resistance.

### DESCRIPTION OF THE RELATED ART

In recent years, there has been a demand for reducing the burden on the environment, and biomass resins that replace petroleum raw materials with biomass raw materials have attracted attention. The use of biomass resins is expected to reduce energy consumption during manufacturing and carbon dioxide emissions during final incineration compared to petroleum-based resins (resins synthesized from petroleum).

Biomass resins are being considered for use in electrical and electronic equipment, the use of which has been increasing in recent years. However, electrical and electronic equipment has a potential risk of ignition due to short-circuit or deterioration of circuits. Therefore, in order to use biomass resin as a material for parts and housings of electrical and electronic equipment, it is necessary to provide flame-retardancy from the viewpoint of safety, such as fire prevention.

Flame-retardants used for imparting flame- retardancy include, for example, phosphorus-based flame-retardants. However, most phosphorus flame-retardants are made from fossil resources, and adding an appropriate amount of phosphorus flame-retardant to provide sufficient flame-retardancy will greatly reduce the biomass content of the overall resin. Therefore, from the viewpoint of balancing the biomass content of the entire resin and flame-retardancy, the use of natural polysaccharides as flame-retardants has been attracting attention.

Patent Document 1 (JP-A 2006-77215) discloses a technology related to flame-retardants containing sugar compounds. In particular, polysaccharides contained in saccharide compounds are compounds whose basic backbone is a cyclic structure with a large amount of hydroxy groups, and they generate water vapor as a result of dehydration and condensation during heating in combustion, resulting in cooling due to a large amount of heat absorption, dilution of combustion gas, and blocking of oxygen. In addition, the carbonization of the polysaccharides after dehydration results in the formation of a film with heat insulating properties (hereinafter referred to as “char” or “carbonized layer”) that has an insulation effect.

However, when a polysaccharide is added to a resin to impart flame-retardancy, depending on the compatibility between the resin and the polysaccharide, it is difficult for the polysaccharide to be uniformly dispersed in the resin, making it difficult to impart flame-retardancy uniformly throughout the resin. In addition, the heat generated when the polysaccharide is added to the resin and mixed causes dehydration and condensation of the polysaccharide, resulting in a decrease in flame-retardancy.

In Patent Document 2 (JP-A 2010-31230), a technology is disclosed for a flame-retardant resin composition that combines impact resistance, moldability, and flame-retardancy, and that contains a phosphorus-containing polysaccharide consisting of a phosphate ester added to the side chain of a natural polysaccharide as a flame-retardant. However, since phosphorus is considered to contribute more to the flame-retardancy of the phosphorus-containing polysaccharides than polysaccharides, the phosphorus-containing polysaccharides with a relatively low concentration of phosphorus in the flame-retardant have lower flame-retardancy than conventionally used phosphorus-based flame-retardants that do not contain polysaccharides, and therefore, in order to use the phosphorus-containing polysaccharides as flame-retardants, further flame-retardancy must be considered. In order to use phosphorus-containing polysaccharides as a flame-retardant, further improvement of flame-retardancy was required.

In addition, Patent Document 3 (JP-A 2003-213149) discloses a technology relating to a flame-retardant biodegradable resin composition in which a biodegradable-retardant having at least a hydroxy group and a carboxy group in the molecule is the main ingredient, and as the biodegradable flame-retardant, citric acid, gluconic acid, lactic acid, malic acid, ester derivatives, or metal salts are exemplified. However, the decomposition temperatures of these compounds are relatively low. In a molded product obtained by injection molding into a mold, there is a problem that sufficient flame-retardancy cannot be obtained because the exemplified compound may decompose.

### SUMMARY OF THE INVENTION

The present invention was made in view of the above problems and circumstances, and an object of the present invention is to provide a flame-retardant resin composition with improved flame-retardancy and impact resistance, a manufacturing method thereof, a flame-retardant resin molded product, and a flame-retardant resin housing.

In order to solve the above problem, the inventor investigated the cause of the above problem, and as a result, the inventor found that in a flame-retardant resin composition containing a resin and a polysaccharide, the sugar backbone in the polysaccharide has at least a basic functional group or a salt of a basic functional group, thereby improving flame resistance and impact resistance. Thus, the present invention has been achieved. In other words, the above-mentioned problems of the present invention are solved by the following means.

A flame-retardant resin composition comprising a resin and a polysaccharide, wherein a sugar backbone in the polysaccharide has at least a basic functional group or a salt of the basic functional group.

By the above means of the present invention, it is possible to provide a flame-retardant resin composition with improved flame retardancy and impact resistance, a manufacturing method thereof, a flame-retardant resin molded product, and a flame-retardant resin housing.

Although the expression mechanism or action mechanism of the effect of the present invention is not clear, it is inferred as follows.

One method for imparting flame-retardancy to resins is to generate water vapor from inside the resin when the resin is ignited, thereby lowering the temperature of the resin and stopping its combustion. Specifically, as mentioned above, it is believed that by including the polysaccharide in the resin, a dehydration-condensation reaction of the polysaccharide proceeds, generating water vapor and lowering the temperature.

In the present invention, in a resin composition containing a resin and a polysaccharide, it is believed that the dehydration-condensation reaction that occurs when the resin composition is heated is promoted by the fact that the sugar backbone in the polysaccharide has a basic functional group or a salt of a basic functional group. The carbonization action, in which the surface of the resin is carbonized at the same time as the generation of water vapor, is promoted, and the flame-retardancy is considered to be improved compared to neutral polysaccharides, such as cellulose, which do not have a basic functional group or a salt of a basic functional group.

In the present invention, a polysaccharide is not completely miscible with a resin, and by dispersing a polysaccharide as fine particles in the resin composition, it is possible to maintain a stable dispersion state (dispersion stabilization) and make a resin composition with uniform characteristics without irregularities, which is thought to improve impact resistance. Therefore, impact resistance is considered to be improved.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein: the FIGURE shows a schematic diagram of a large-size photocopier 10 enclosed in a flame-retardant resin housing of the present invention.

### DETAILED DESCRIPTION

Hereinafter, one or more embodiments of the present invention will be described with reference to the drawings. However, the scope of the invention is not limited to the disclosed embodiments.

The flame-retardant resin composition of the present invention is a flame-retardant resin composition containing a resin and a polysaccharide, characterized in that the sugar backbone in the polysaccharide has, at least, a basic functional group or a salt of the basic functional group. This feature is a technical feature common to or corresponding to the following embodiments.

In terms of the effect of the present invention, it is preferred that the basic functional group is an amino group or a substituted amino group.

As an embodiment of the present invention, from the viewpoint of appearance and impact resistance, it is preferred that the sugar backbone having the amino group or substituted amino group is a glucosamine backbone or an N-acetylglucosamine backbone, respectively.

From the viewpoint of appearance and impact resistance, it is preferred that the polysaccharide is chitosan or chitin.

As an embodiment of the present invention, from the viewpoint of ease of handling, it is preferred that the resin is a thermoplastic resin, and from the viewpoint of impact resistance, the thermoplastic resin is an amorphous resin.

From the viewpoint of appearance, flame-retardancy and impact resistance, it is preferred that the thermoplastic resin contains at least one of an ABS resin, polystyrene, polymethyl methacrylate or polycarbonate.

From the viewpoints of appearance, flame-retardancy and impact resistance, it is preferred that the average primary particle diameter of the polysaccharide dispersed in a particle state is in the range of 0.10 to 300.0 µm.

From the viewpoint of appearance and flame-retardancy, it is preferred that the content of the polysaccharide is in the range of 5 to 40 mass% of the total mass of the flame-retardant resin composition.

The method for manufacturing the flame-retardant resin composition of the present invention is characterized in that the method for manufacturing the flame-retardant resin composition of the present invention has the processes of dry-milling the polysaccharide and melt-kneading the thermoplastic resin and the polysaccharide.

The method for manufacturing a flame-retardant resin composition of the present invention is a method for manufacturing a flame-retardant resin composition of the present invention, characterized in that it has the process of melt-kneading the thermoplastic resin and the polysaccharide, and the number of melt-kneading is two or more times.

The flame-retardant resin molded product of the present invention is characterized in that it is formed using the flame-retardant resin composition of the present invention, and the flame-retardant resin housing of the present invention is characterized in that it includes the flame-retardant resin molded product of the present invention.

Hereinafter, the present invention, its components, and the forms and embodiments for carrying out the invention will be described in detail. In this application, “to” is used in the sense of including the numerical values described before and after “to” as lower and upper limits.

### Outline of Flame-Retardant Resin Composition

The flame-retardant resin composition of the present invention is a flame-retardant resin composition containing a resin and a polysaccharide, characterized in that a sugar backbone in the polysaccharide has, at least, a basic functional group or a salt of a basic functional group. In the present invention, the term “flame-retardant resin composition” refers to a resin composition that has the following “flame-retardant properties”.

The “flame-retardancy” is one of the heat resistance properties and refers to the property of being slow burning but continuing to burn to some extent. Specifically, it means meeting the acceptance criteria in the UL94 standard established by Underwriters Laboratories (UL) of the United States, and in detail, it means meeting the acceptance criteria in UL94HB in the UL94 test (combustion test of plastic materials for equipment parts). In addition, it is preferable to meet the criteria for V-2 under UL94V, more preferable to meet the criteria for V-1, and even more preferable to meet the criteria for V-0.

The term “combustion” refers to an oxidation reaction involving the generation of light and heat, and combustion requires three elements: combustibles, an oxygen supply source, and an ignition source. Once a resin (combustible material) is ignited (ignition source), the following phenomena are repeated and combustion continues.
(a) Resin (combustible material) melts and decomposes due to high temperature, and a large amount of combustible gas is generated.
(b) The high temperature environment causes the combustible gas to radicalize and accelerate a chemical reaction with oxygen in the air (oxygen source), which generates a considerable amount of light and heat.
(c) The generated heat maintains the high temperature, so the decomposition of the resin continues.

Therefore, combustion may be stopped by either lowering the temperature, cutting off the oxygen supply, or removing flammable gases, and by designing the resin so that this phenomenon occurs when the fire is lit, the resin may be given flame-retardant properties.

Specifically, for example, water vapor is generated from inside the resin to lower its temperature (cooling by a large amount of heat absorption), a large amount of nonflammable gas is generated from inside the resin to lower the oxygen concentration and cut off the oxygen supply, the surface of the resin is carbonized to form a barrier layer (equivalent to “char” or “carbonized layer” in the present invention).

In the present invention, the resin composition contains a polysaccharide, and furthermore, a sugar backbone contained in the polysaccharide has at least a basic functional group or a salt of a basic functional group, which is considered to enable the above phenomena to occur and to provide flame-retardant properties.

The flame-retardant resin composition of the present invention is excellent in flame-retardancy and impact resistance, and may be used as a housing and a component in an electronic device by being molded into a suitable shape. Moreover, when used as a housing, it is preferable that the appearance is excellent.

### Structure of Flame-Retardant Resin Composition

The flame-retardant resin composition of the present invention is a flame-retardant resin composition containing a resin and a polysaccharide, wherein a sugar backbone contained in the polysaccharide is at least a basic functional group or a salt of a basic functional group. From the viewpoint of reducing environmental load, the material used in the flame-retardant resin composition of the present invention is preferably a biomass material, but materials other than the biomass material may be used.

### [1. Polysaccharide]

The flame-retardant resin composition of the present invention contains a polysaccharide, and a sugar backbone contained in the polysaccharide has at least a basic functional group or a salt of a basic functional group. The flame-retardant resin composition of the present invention may be imparted with flame retardancy by containing the polysaccharide.

In the present invention, the term “polysaccharide” refers to a substance obtained by dehydration condensation of many monosaccharides via glycosidic bonds, and is a general term for them. The number of types of monosaccharides that constitute the constituent units of the polysaccharide may be one or two or more.

The degree of polymerization of the polysaccharide is preferably in the range of 50 to 20,000, more preferably in the range of 200 to 15,000, and even more preferably in the range of 200 to 11,000.

The molecular weight of the polysaccharide is preferably be in the range of 10,000 to 250,000 in terms of weight average molecular weight on a polystyrene basis as determined by gel permeation chromatography (GPC), and it is more preferred to be in the range of 20,000 to 80,000.

The term “monosaccharide” refers to a sugar that cannot be hydrolyzed further and is a generic term. In terms of structure, it is a chain polyhydroxy compound with an aldehyde or a ketone group, and usually exist in an intramolecular hemiacetalized cyclic form. The monosaccharide concerned is preferably a pentose or a hexose, and a hexose is more preferred. In the present invention, a “sugar backbone” refers to a backbone structure of monosaccharides.

For example, when only one type of monosaccharide (A) is used as a building block of a polysaccharide, the backbone structure of monosaccharide A corresponds to the sugar backbone. In the present invention, the sugar backbone is characterized by having at least a basic functional group or a salt of a basic functional group, in which case, in the backbone structure of monosaccharide A, it has at least a basic functional group or a salt of a basic functional group.

When the type of monosaccharide that is the building block of the polysaccharide is two types (A and B), the backbone structure of monosaccharides A and B corresponds to the sugar backbone. In this case, at least a basic functional group or a salt of a basic functional group is present in the backbone structure of monosaccharide A or B.

Similarly, when there are three or more kinds of monosaccharides that are the building blocks of polysaccharides, the backbone structure of each monosaccharide corresponds to the sugar backbone, and at least a basic functional group or a salt of a basic functional group is present in the backbone structure of each monosaccharide. Polysaccharides do not necessarily have to have a structure with repeating units.

In the present invention, “the sugar backbone in the polysaccharide has at least one or more basic functional groups other than a hydroxy group” means that the monosaccharide backbone in the polysaccharide has at least one or more basic functional groups other than a hydroxy group, the basic functional group may form a salt. Hereinafter, “basic functional group or salt of a basic functional group” is also collectively referred to as “basic functional group”. In the present invention, a hydroxy group is not included in basic functional groups. Polysaccharides may have an acidic functional group in addition to a basic functional group to the extent that they do not interfere with the effects of the present invention, and further, the acidic functional group may form salts. From the viewpoint of expressing the effect of the present invention, it is preferable that the total number of basic functional groups and salts of basic functional groups in the entire polysaccharide is greater than the total number of acidic functional groups and salts of the acidic functional groups.

From the viewpoint that it is preferable to use biomass materials in the present invention, it is preferable to use natural polysaccharides for the polysaccharides. However, the polysaccharides for the present invention are not limited to those of natural origin.

They may also be partially modified from natural polysaccharides. Specifically, a basic functional group may be introduced into a polysaccharide having no basic functional group to obtain the polysaccharide according to the present invention, or, if necessary, they may be made into derivatives.

Examples of the derivatives of polysaccharide include compounds in which atoms other than basic functional groups are replaced with different atoms or substituents, for example, a hydrogen atom in a polysaccharide is replaced with a substituent such as a halogen group (halogen atom) or a hydrocarbon group. Also, compounds obtained by bonding with other compounds or other molecules of the polysaccharide via functional groups other than basic functional groups, such as ester derivatives and ether derivatives obtained by reacting hydroxy groups in polysaccharides with compounds having functional groups having reactivity with hydroxy groups, and cross-linked polysaccharides described below. The following are examples of the cross-linked polysaccharide.

Examples of the basic functional group include an amino group (primary amino group), a substituted amino group (secondary amino group and tertiary amino group), an amide group, a pyridyl group, a pyridine group, a pyrrolidone group, an imidazole group, and an imine group, and among these, an amino group or a substituted amino group (primary amino group, secondary amino group, or tertiary amino group) is preferable.

Examples of the salt of a basic functional group include quaternary ammonium salts, and examples thereof include salts with a chlorine ion, a bromine ion, an alkyl sulfate ester ion having 1 or 2 carbon atoms, a fatty acid ion having 1 to 12 carbon atoms, and a benzenesulfonic acid ion substituted with 1 to 3 alkyl groups having 1 to 3 carbon atoms.

Among them, a salt with a divalent or higher anion is preferable. By being salts with more than divalent anions, a cross-linked structure is formed within or between molecules, resulting in a rigid structure. This dramatically improves heat resistance and prevents deformation of the flame-retardant resin composition during melt-kneading and molding, resulting in superior strength and appearance.

Examples of the monosaccharide having a basic functional group include glucosamine, galactosamine, mannosamine, and their derivatives, and monosaccharides having a salts of a basic functional group include these salts.

Derivatives include N-substituted compounds or salts with inorganic salts such as sulfuric acid and organic acids such as acetic acid. Among them, N-substituted products with an organic acid are preferred, and N-acyl-substituted products are more preferred.

Preferred N-acyl substituents include, for example, N-formyl substituents, N-acetyl substituents, N-propionyl substituents, N-butyryl substituents, N-isobutyryl substituents, and N-acetyl substituents. N-isobutyryl substituent, N-valeryl substituent, N-isovaleryl substituent, and N-pivaloyl substituent. Among them, N-acetyl substituents are preferred, and N-acetyl substituents include, for example, N-acetylglucosamine, N-acetylgalactosamine, N N-acetylglucosamine, N-acetylgalactosamine, and N-acetylmannosamine.

Monosaccharides having a functional group may have a functional group other than the basic functional group, and may also have an acidic functional group or a salt of an acidic functional group (hereinafter referred to as an “acidic functional group”). The Monosaccharides having both basic and acidic functional groups include muramic acid, N-acetylglucosamine-4-sulfate, N-acetylgalactosamine-4-sulfate, neuraminic acid 4-sulfate, neuraminic acid, and N-acetylneuraminic acid.

When there are two or more kinds of monosaccharides that are the building blocks of polysaccharides, at least one of them falls under the above monosaccharides, but other monosaccharides are not restricted and may or may not fall under the above monosaccharides.

Other monosaccharides that do not fall under the above monosaccharides include ribose, arabinose, xylose, liquose, xylulose, ribulose, deoxyribose, glucose, mannose, galactose, fructose, sorbitose, tagatose, fucose, fuculose, and rhamnose.

Other monosaccharides may also have an acidic functional group. The acidic functional groups include carboxy groups, and sulfooxy group. Monosaccharides having a carboxy group include uronic acids. Examples of uronic acids include glucuronic acid, azuronic acid, mannuronic acid, and galacturonic acid. Monosaccharides having a sulfooxy group include, for example, galactose-3-sulfate.

Polysaccharides in which the sugar backbone is composed of a single monosaccharide include, for example, chitosan composed of glucosamine and chitin composed of N-acetylglucosamine. However, as for natural chitin, it contains not only N-acetylglucosamine but also glucosamine, and the composition ratio of N-acetylglucosamine to glucosamine is about 9:1.

Polysaccharides in which the sugar backbone is composed of two monosaccharides include, for example, hyaluronic acid, chondroitin, chondroitin 4-sulfate, chondroitin 6-sulfate, heparin, heparan sulfate, dermatan sulfate, and keratan sulfate.

Cross-linked polysaccharides may be used as derivatives of polysaccharides. In the present invention, a “cross-linked polysaccharide” refers to a compound having a structure in which the hydroxy groups in the sugar chain are cross-linked in two or more polysaccharide molecules. Cross-linked polysaccharides are obtained, for example, by cross-linking hydroxy groups between at least different molecules of polysaccharides using a cross-linking agent. Two hydroxy groups within the same molecule may be cross-linked using a cross-linking agent, provided that the cross-linking is between different molecules.

The crosslinked polysaccharide used in the present invention is a crosslinked form of the above polysaccharide, and the above polysaccharides may be used without limitation as the polysaccharides constituting the crosslinked polysaccharide.

As a cross-linking agent, it is preferable that the cross-linking agent is a compound having a hydroxy group and two or more functional groups having reactivity with the hydroxy group. The functional groups having reactivity with hydroxy groups include, for example, an epoxy group, a chloro group, a silyl group, an isocyanate group, and an acid anhydride. The cross-linking agent includes, for example, epichlorohydrin, hexamethylene diisocyanate, and tetraethyl silicate. Epichlorohydrin is preferred among these.

Cross-linking of polysaccharides using epichlorohydrin may be performed, for example, by the reactions shown in Schemes (I-1) and (I-2) below. In each scheme, an asterisk “*” indicates the bonding portion with the backbone structure in which the monosaccharide is dehydrated and condensed by glycosidic linkages.

Scheme (I-1) is carried out under alkaline conditions, and the epoxy ring of epichlorohydrin opens the ring and reacts with the OH group of the polysaccharide molecule to give Intermediate (P). Furthermore, according to Scheme (I-2), the terminal chloro group derived from epichlorohydrin in Intermediate (P) reacts with the OH group of another polysaccharide molecule, and the two polysaccharide molecules are connected by a linkage group (—CH₂—CH(OH)—CH₂—).

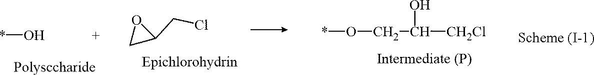

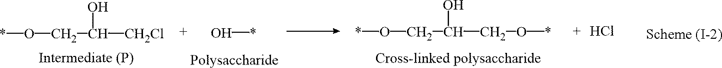

The degree of cross-linking in cross-linked polysaccharides may be adjusted by the amount of cross-linking agent added to the polysaccharide. The degree of cross-linking in the polysaccharide should be adjusted so that the weight average molecular weight of the resulting cross-linked polysaccharide is within the preferred range of the weight average molecular weight of the polysaccharide mentioned above.

To determine whether the resin composition contains a polysaccharide and whether the sugar backbone in the polysaccharide has a basic functional group or a salt of a basic functional group, the resin composition is pulverized, washed and extracted with a solvent, and only the polysaccharide is separated, then hydrolyzed to monosaccharides, and the molecular structure of the monosaccharide is determined by identifying the molecular structure of the monosaccharide by high performance chromatography.

In the flame-retardant resin composition of the present invention, polysaccharides are considered to be dispersed in a particle state, and by adjusting the particle diameter within a specific range, it is considered possible to stably maintain the dispersed state of polysaccharides. It is also considered that the characteristics of the flame-retardant resin composition are uniformly expressed by stabilizing the dispersion state of polysaccharides. Specifically, it is thought to be possible to provide even and uniform flame-retardancy, impact resistance, and appearance in flame-retardant resin molded products.

As for appearance, if there is any defect, it is necessary to modify the mold and change the molding conditions (e.g., cooling time), so it is desirable to have excellent appearance from the viewpoint of production efficiency.

The average primary particle diameter of the polysaccharide particles is preferably in the range of 0.10 to 300.0 µm, more preferably in the range of 0.10 to 80.0 µm, and even more preferably in the range of 0.10 to 30.0 µm.

The average primary particle size of polysaccharide particles may be measured by the following method. A scanning electron microscope (SEM) (manufactured by JEOL Ltd.) is used to take a magnified photograph (SEM image) of the flame-retardant resin composition at 1000 times magnification, which is then captured by a scanner into a computer. The SEM image is then binarized by the automatic image processing analyzer “LUZEX (registered trademark) AP” (Nireco Corporation) using software Ver. 1.3.2. And then, the diameters of 300 randomly selected polysaccharide particles are calculated as horizontal Feret diameters, and the average value thereof is defined as an average primary particle size. The “horizontal Feret diameter” refers to the length of the side parallel to the x-axis of the bounding rectangle when the image of polysaccharide particles is processed by binarization.

The average primary particle diameter of polysaccharides may be adjusted within the above range by using the method for manufacturing the flame-retardant resin composition of the present invention described below. In particular, many natural polysaccharides have relatively large particle diameters, but by using this manufacturing method, the particle diameters of even natural polysaccharides may be made relatively small.

Although the manufacturing method for the flame-retardant resin composition of the present invention described below uses the melt-kneading method, when the resin is a resin other than a thermoplastic resin, the average primary particle diameter of the polysaccharide may be adjusted within the above range by using a known method in which each component is uniformly mixed after a dry-milling process (pretreatment) of the polysaccharide.

In addition to flame-retardancy, from the viewpoint of impact resistance and appearance, it is preferable that the polysaccharide content is in the range of 5 to 40 mass%, and more preferable in the range of 20 to 30 mass% with respect to the total mass of the flame- retardant resin composition.

### [2. Resin]

The flame-retardant resin composition of the present invention contains a resin. The type of resin is not particularly restricted and includes a thermoplastic resin, a thermosetting resin, a light-curing resin, and heat- and light-curing resin. Among them, from the viewpoint of easy handling, it is preferable that the resin is a thermoplastic resin.

From the viewpoint of reducing environmental load, the resin according to the present invention is preferably a biomass resin, but the present invention may also be applied to resins other than a biomass resin. Also, a biomass resin and a resin other than the biomass resin may be used in combination.

The content of the resin is preferably in the range of 30 to 95 mass%, 40 to 90 mass% is more preferable, and 50 to 80 mass% is even more preferable with respect to the total mass of the flame-retardant resin composition.

### [2.1. Thermoplastic Resin]

From the viewpoint of ease of handling, it is preferable that the resin of the present invention is a thermoplastic resin. Although the type of thermoplastic resin is not restricted, it is preferable that the softening point of the thermoplastic resin is less than 200° C. from the viewpoint of being able to suppress the decomposition of polysaccharides and having excellent impact resistance and appearance in addition to flame-retardancy.

The thermoplastic resin may be crystalline or amorphous, but from the viewpoint of impact resistance, it is preferable that the thermoplastic resin is an amorphous resin.

In the present invention, the term “amorphous resin” refers to a resin in which no clear endothermic peak is recognized in differential scanning calorimetry (DSC). In other words, it refers to a resin that does not have a melting point (a clear endothermic peak in the DSC curve measured using a differential scanning calorimetry (DSC) device) and have a relatively high glass transition point (Tg). On the other hand, the term “crystalline resin” refers to a resin that has a clear endothermic peak in DSC, rather than a staircase-like endothermic change.

The “clear endothermic peak” here specifically refers to a peak with an endothermic peak width at half maximum within 15° C. when measured at a temperature increase rate of 10° C./min in DSC measurements. For example, a differential scanning calorimeter (“Diamond DSC”, made by Perkin Elmer) may be used for DSC measurement, and the melting point of indium and zinc may be used to correct the temperature of the detection section of this device, and the heat of melting of indium may be used to correct the heat quantity.

When the resin is a crystalline resin, it has a crystallization temperature. In crystalline resins, the crystallization rate is fastest at a certain temperature during the cooling process, and this temperature is called the “crystallization temperature. Therefore, it is possible to determine whether the resin is crystalline or amorphous by the presence or absence of the crystallization temperature.

The crystallization temperature may be measured by the following method. Using a differential scanning calorimeter (DSC) such as “DSC Pyris 1” (made by Perkin Elmer Japan Co., Ltd.) or “DSC7020” (made by Hitachi High-Tech Science Corporation), a sample (about 5 mg) is heated under a nitrogen atmosphere (20 mL/min) to the temperature set for each resin. The temperature is held at that temperature for 3 minutes, cooled to 30° C. at 10° C./minute, held at 30° C. for 1 minute, and then increased to reache the above temperature at 10° C./minute. The melting point (Tm) then may be calculated from the peak apex of the crystal melting peak during the temperature increase process, and the crystallization temperature (Tc) may be calculated from the peak apex of the crystallization peak during the temperature decrease process. If multiple crystal melting peaks are observed, the melting point (Tm) is the peak on the high-temperature side.

Crystalline resins are prone to mold shrinkage due to the formation of a crystalline structure during the cooling process after melting and molding. On the other hand, amorphous resins are less prone to mold shrinkage and may maintain the polysaccharide in a dispersed state in the flame-retardant resin composition, and thus are considered to have better impact resistance.

Thermoplastic resins include, for example, polystyrene resins, polymethyl methacrylate, polycarbonate, aromatic polyesters, polyphenylene sulfide, polyolefin resins, polyamide-imide, polyetheretherketone, polyethersulfone, polyimide, poly(vinyl chloride), polyamide, polyacetal, polylactic acid, polystyrene thermoplastic elastomer, polyolefin thermoplastic elastomer, polyurethane thermoplastic elastomer, 1,2-polybutadiene thermoplastic elastomer, thermoplastic elastomers of ethylene-vinyl acetate copolymer, fluoro-rubber thermoplastic elastomers, and chlorinated polyethylene thermoplastic elastomers may be cited.

From the viewpoint of reducing environmental load, thermoplastic biomass resins may be used as thermoplastic resins. Examples of the thermoplastic biomass resin include aliphatic polyesters, polyamino acids, polyvinyl alcohol, poly(vinyl alcohol), polyalkylene glycols, and copolymers containing these polymers. Thermoplastic biomass resins may also be combined with resins other than thermoplastic biomass resins to create a thermoplastic resin that has the advantages of both. One type of these thermoplastic resins may be used alone or in combination with two or more types.

Polystyrene resins include polystyrene, acrylonitrile-styrene copolymer (AS resin), and acrylonitrile-butadiene-styrene copolymer (ABS resin).

Aromatic polyesters include aromatic polyesters having a structure in which an aromatic dicarboxylic acid or its ester derivative component and a diol component such as an aliphatic diol or alicyclic diol are linked by an ester reaction. Specific examples thereof include polyethylene terephthalate, polypropylene terephthalate, polybutylene terephthalate, polyethylene naphthalate, polybutylene naphthalate, and polyethylene-1,2-bis(phenoxy)ethane-4,4′-dicarboxylate, as well as copolymerized polyesters such as polyethylene isophthalate/terephthalate, polybutylene terephthalate/isophthalate, and polybutylene terephthalate/decanedicarboxylate.

Aliphatic polyesters include polyoxyacids, which are copolymers of oxyacids, and polycondensates of aliphatic diols and aliphatic dicarboxylic acids. Polyoxy acids include, for example, poly-L-lactic acid (PLLA), poly-D-lactic acid (PDLA), random copolymer of L-lactic acid and D-lactic acid, polylactic acid such as stereocomplexes of L-lactic acid and D-lactic acid, polycaprolactone, polyhydroxybutyric acid, and polyhydroxyvaleric acid. Polycondensates of aliphatic diols and aliphatic dicarboxylic acids include, for example, polyethylene succinate, polybutylene succinate (PBS), and polybutylene adipate.

From the viewpoint of impact resistance, it is preferable that the thermoplastic resin is an amorphous resin, especially ABS resin, polystyrene, polymethyl methacrylate or polycarbonate. Two or more types of thermoplastic resins may be used in combination, and it is preferable to use at least one or more of these resins.

Commercial products of thermoplastic resins include, for example, TOYOLAC (registered trademark) (ABS resin, manufactured by Toray Industries, Inc.), SANTAC (registered trademark) (ABS resin, manufactured by A & L Japan, Ltd.), TOYOSTYROL (registered trademark) (polystyrene, manufactured by Toyo Styrene Co.), ACRYPET (registered trademark) (polymethyl methacrylate, manufactured by Mitsubishi Chemical Corporation), Taflon (registered trademark) (polycarbonate, manufactured by Idemitsu Kosan Co., Ltd.), Panlite (registered trademark) (polycarbonate, manufactured by Teijin Chemicals Limited), Prime Polypro (registered trademark) (manufactured by Prime Polypropylene Co.), DURANEX (registered trademark) (polybutylene terephthalate, manufactured by Polyplastics Corporation), CLAPET (registered trademark) (polyethylene terephthalate, manufactured by Kuraray Co.), “Aramin” (polyamide, manufactured by Toray Industries, Inc.), “Lacia (registered trademark)” (polylactic acid, manufactured by Mitsui Chemicals, Inc.), and “TERRAMAC (registered trademark)” (polylactic acid, manufactured by Unitika Ltd.).

### [2.1.1. Polystyrene-Based Resin]

The thermoplastic resin according to the present invention is preferably a polystyrene-based resin from the viewpoint of impact resistance, and among them, ABS resin or polystyrene is preferred.

In the present invention, the “polystyrene-based resin” refers to a polymeric material containing at least a styrene-based monomer as a monomer component. Here, “styrene monomer” refers to a monomer having a styrene backbone in its structure.

The styrene-based monomer is not particularly limited as long as it is a monomer having a styrene backbone in its structure. Examples thereof include styrene, core alkyl-substituted styrene (o-methylstyrene, m-methylstyrene, p-methylstyrene, 2,4-dimethylstyrene, 4-ethylstyrene, and p-tert-butylstyrene), α-alkyl substituted styrene (α-methylstyrene). Among them, styrene is preferred.

The polystyrene resin may be a homopolymer of a styrene monomer or a copolymer of a styrene monomer and other monomer components. Monomer components that may be copolymerized with a styrene monomer include, for example, unsaturated carboxylic acid alkyl ester monomers such as alkyl methacrylate monomers (methyl methacrylate, cyclohexyl methacrylate, methyl phenyl methacrylate, and isopropyl methacrylate), and alkyl acrylate monomers (methyl acrylate, ethyl acrylate, butyl acrylate, 2-ethylhexyl acrylate, and cyclohexyl acrylate).

Other examples include unsaturated carboxylic acid monomers (methacrylic acid, acrylic acid, itaconic acid, maleic acid, fumaric acid, and cinnamic acid), unsaturated dicarboxylic anhydride monomers (maleic anhydride), unsaturated nitrile monomers (acrylonitrile and methacrylonitrile), conjugated diene monomers (1,3-butadiene, 2-methyl-1,3-butadiene (isoprene), 2,3-dimethyl-1,3-butadiene, 1,3-pentadiene, and 1,3-hexadiene). In addition, the styrene-based monomer and one other monomer component may be copolymerized, or two or more other monomer components may be copolymerized.

The ratio of copolymerization of other monomer component is preferably 50 mass% or less, more preferably 40 mass% or less, and still more preferably 30 mass% or less in relation to the total mass of styrenic monomer.

In the present invention, the “ABS resin” refers to an acrylonitrile-butadiene-styrene copolymer. In addition, the “polystyrene” refers to a homopolymer of the above styrene monomer.

From the viewpoint of heat resistance, preferred polystyrene resins include acrylonitrile-butadiene-styrene copolymer (ABS resin), polystyrene, acrylonitrile-styrene copolymer (AS resin), and styrene-methacrylic acid copolymer, and styrene-maleic anhydride copolymer.

In acrylonitrile-butadiene-styrene copolymers (ABS resins), from the viewpoint of impact resistance and heat resistance, the acrylonitrile monomer ratio in the copolymer is preferably in the range of 1 to 40 mass% of relative to the total mass of the ABS resin, more preferably in the range of 1 to 30 mass%, and still more preferably in the range of 1 to 25 mass%.

In the styrene-methacrylic acid copolymer, from the viewpoint of heat resistance, it is preferred that the percentage of methacrylic acid monomer in the copolymer is 0.1 mass% or more of the total mass of the styrene-methacrylic acid copolymer. When transparency is to be imparted, it is preferable that the percentage is 50 mass% or less. When both heat resistance and transparency are required, it is preferable that the content is in the range of 0.1 to 40 mass%, and even more preferable that it is in the range of 0.1 to 30 mass%.

In styrene-maleic anhydride copolymers, from the viewpoint of heat resistance, it is preferred that the percentage of maleic anhydride monomer in the copolymer is 0.1 mass% or more of the total mass of the styrene-maleic anhydride copolymer. When transparency is to be imparted, it is preferable that the percentage is 50 mass% or less. When both heat resistance and transparency are to be achieved, it is more preferable that the percentage is in the range of 0.1 to 40 mass%, and even more preferable that it is in the range of 0.1 to 30 mass%.

Commercially available polystyrene resins include, for example, TOYOLAC (registered trademark) (ABS resin, manufactured by Toray Industries, Inc.), SANTAC (registered trademark) (ABS resin, manufactured by A&L Corporation of Japan), TOYOSTYROL (registered trademark) (polystyrene, manufactured by Toyostyrene Co.), CLEAREN (registered trademark) (styrene-butadiene copolymer, manufactured by DENKA CORPORATION), ASAFLEX (registered trademark) (styrene-butadiene copolymer, manufactured by Asahi Kasei Chemicals Corporation), Styrolux (registered trademark) (styrene-butadiene copolymer, manufactured by BASF Corporation), and PSJ (registered trademark)-Polystyrene (polystyrene, manufactured by PS Japan Corporation).

It is preferable that the polystyrene resin content is 50 mass% or more, 60 mass% or more is more preferable, and 80 mass% or more is even more preferable in relation to the total mass of the thermoplastic resin. In the flame-retardant resin composition of the present invention, it is particularly preferred that the thermoplastic resin is composed solely of polystyrene resin.

### [2.1.2. Polymethyl Methacrylate]

It is preferred that the thermoplastic resin of the present invention is polymethyl methacrylate from the viewpoint of impact resistance.

The polymethyl methacrylate may be a homopolymer of methyl methacrylate or a copolymer of methyl methacrylate and other monomer components. Monomer components that may copolymerize with methyl methacrylate include, for example, methyl acrylate, ethyl (meth)acrylate, propyl (meth)acrylate, isopropyl (meth)acrylate, butyl (meth)acrylate, amyl (meth)acrylate, hexyl (meth)acrylate, octyl (meth)acrylate, 2-ethylhexyl (meth)acrylate, cyclohexyl (meth)acrylate, dodecyl (meth)acrylate, octadecyl (meth)acrylate, phenyl (meth)acrylate, and benzyl (meth)acrylate. In this specification, (meth)acrylate represents both acrylate and methacrylate. Methyl methacrylate may be copolymerized with one other monomer component or two or more other monomer components.

In polymethyl methacrylate, from the viewpoint of impact resistance and heat resistance, it is preferred that the percentage of methyl methacrylate in the copolymer is in the range of 50 to 99 mass%, more preferably in the range of 60 to 95 mass%, and still more preferably in the range of 70 to 95 mass% by mass relative to the total mass of the polymethyl methacrylate.

Examples of commercially available polymethyl methacrylate include ACRYPET (registered trademark) (manufactured by Mitsubishi Chemical Corporation).

It is preferred that the content of polymethyl methacrylate is 50 mass% or more, more preferably 60 mass% or more, and still more preferably 80 mass% or more in relation to the total mass of the thermoplastic resin. In the flame-retardant resin composition of the present invention, the thermoplastic resin may comprise only polymethyl methacrylate.

### [2.1.3. Polycarbonate]

The thermoplastic resin of the present invention is preferably polycarbonate from the viewpoint of impact resistance.

A polycarbonate is a compound in which the bond between monomers consists of carbonate groups and has a structure represented by the following Formula (1).

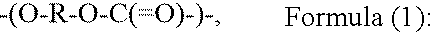

wherein R represents a hydrocarbon group.

A polycarbonate is obtained by the reaction of a divalent hydroxy compound with a carbonate precursor represented by phosgene. Depending on the structure of the divalent hydroxy compound, aromatic polycarbonate, aliphatic polycarbonate, and alicyclic polycarbonate are obtained. In the present invention, aromatic polycarbonate is more preferred from the viewpoint of impact resistance.

Examples of the divalent aromatic hydroxy compound include bis(hydroxyaryl)alkanes such as 2,2′-bis(4-hydroxyphenyl)propane [bisphenol A], 1,1-bis(4-hydroxyphenyl)ethane, 2,2-bis(4-hydroxyphenyl)butane [bisphenol B], 2,2-bis(4-hydroxyphenyl)octane, 2,2-bis(4-hydroxy-3-methylphenyl)propane, 1,1-bis(3-tert-butyl-4-hydroxyphenyl)propane, 2,2-bis(4-hydroxy-3,5-dimethylphenyl)propane, 2,2-bis(3-phenyl-4-hydroxyphenyl)propane, 2,2-bis(3-cyclohexyl-4-hydroxyphenyl)propane, 1,1-bis(4-hydroxyphenyl)-1-phenylethane [bisphenol AP], and bis(4-hydroxyphenyl)diphenylmethane [bisphenol BP].

In addition, examples include bis(hydroxyphenyl)cycloalkanes such as 1,1-bis (4-hydroxyphenyl)cyclopentane, 1,1-bis(4-hydroxyphenyl)cyclohexane [bisphenol Z], 1,1 bis(hydroxyaryl)cycloalkanes such as 1,1-bis(4-hydroxyphenyl)-3,3,5-trimethylcyclohexane [bisphenol TMC]. Further examples include cardo structure-containing bisphenols such as 9,9-bis(4-hydroxyphenyl)fluorene and 9,9-bis(4-hydroxy-3-methylphenyl)fluorene; dihydroxy diaryl ethers such as 4,4′-dihydroxydiphenyl ether, 4,4′-dihydroxy-3,3′-dimethyldiphenyl ether; and dihydroxydiarylsulfides such as 4,4′-dihydroxydiphenylsulfide and 4,4′-dihydroxy-3,3′-dimethyldiphenylsulfide.

Further examples include dihydroxydiarylsulfoxides such as 4,4′-dihydroxydiphenylsulfoxide and 4,4′-dihydroxy-3,3′-dimethyldiphenylsulfoxide; dihydroxydiarylsulfones such as 4,4′-dihydroxydiphenylsulfone and 4,4′-dihydroxy-3,3′-dimethyldiphenylsulfone. Other examples include hydroquinone, resorcinol, and 4,4′-dihydroxydiphenyl.

These may be used singly or in combination. Among them, bis(4-hydroxyphenyl)alkanes are preferred, and in particular, bisphenol A is preferred.

Trivalent or more aromatic hydroxy compounds and the above divalent aromatic hydroxy compounds may also be used in combination to make polycarbonates with a branched structure. The trivalent or more aromatic hydroxy compounds include, for example, phloroglucine and phloroglucide, 4,6-dimethyl-2,4,6-tris(4-hydroxydiphenyl)heptene, and 2,4,6-trimethyl-2,4,6-tris(4-hydroxyphenyl)heptane, 1,3,5-tris(4- 1,3,5-tris(4-hydroxyphenyl)benzene, 1,1,1-tris(4-hydroxyphenyl)ethane, 1,1,1-tris(3,5-dimethyl-4-hydroxyphenyl)ethane, 2,6-bis(2-hydroxy-5-methylbenzyl)-4-methylphenol and trisphenol such as 4-{4-[1,1-bis(4-hydroxyphenyl)ethyl]benzenel-α,α-dimethylbenzylphenol.

Also, other examples include tetra(4-hydroxyphenyl)methane, bis(2,4-dihydroxyphenyl)ketone, 1,4-bis(4,4-dihydroxytriphenylmethyl)benzene. Other examples include trimellitic acid, pyromellitic acid, benzophenone tetracarboxylic acid, and their acid chlorides. Among them, 1,1,1-tris(4-hydroxyphenyl)ethane or 1,1,1-tris(3,5-dimethyl-4 hydroxyphenyl)ethane is preferred, and 1,1,1-tris(4-hydroxyphenyl)ethane is more preferred.

Examples of carbonate precursors include phosgene, diarylcarbonates (diphenylcarbonate, ditoryl carbonate), dialkylcarbonates (dimethylcarbonate, diethylcarbonate), dihaloformate of divalent phenol. Among them, phosgene is preferred. These may be used singly or in combination.

Examples of commercially available polycarbonates include Taflon (registered trademark) (Idemitsu Kosan Co., Ltd.), Panlite (registered trademark) (Teijin Chemicals Limited), Iupilon (registered trademark) (Mitsubishi Engineering-Plastics Corporation), and NOVAREX (registered trademark) (manufactured by Mitsubishi Engineering-Plastics Corporation).

It is preferred that the content of polycarbonate is 50 mass% or more, more preferably 60 mass% or more, and still more preferably 80 mass% or more in relation to the total mass of the thermoplastic resin. In the flame-retardant resin composition of the present invention, the thermoplastic resin may consist solely of polycarbonate.

### [3. Other Additives]

The flame-retardant resin composition of the present invention may contain other additives according to the purpose and to the extent that the effect of the present invention is not impaired.

Examples of the additive include antioxidants, fillers, and crystal core agents. In the present invention, the above polysaccharides may be used in combination with commonly used flame-retardants. Examples of flame-retardants include phosphorus-based flame-retardants (including red phosphorus), bromine-based flame-retardants, chlorine-based flame-retardants, antimony-based flame-retardants, boron-based flame-retardants, nitrogen-based flame-retardants, metal hydroxide-based flame-retardants, and silicone-based flame-retardants.

The content of the additive is preferably in the range of 0 to 30 mass%, and more preferably in the range of 0 to 20 mass% relative to the total mass of the flame-retardant resin composition.

### Manufacturing Method of Flame-Retardant Resin Composition

The method for manufacturing the flame-retardant resin composition of the present invention is characterized by the processes of dry-milling the polysaccharides and melt-kneading the polysaccharides with the thermoplastic resin.

The method for manufacturing the flame-retardant resin composition of the present invention is characterized in that it has the process of melt-kneading the thermoplastic resin and the polysaccharides, and the number of times of melt-kneading is two or more.

Although the method for manufacturing the flame-retardant resin composition of the present invention is not particularly restricted, when the resin is a thermoplastic resin, the melt-kneading method is preferred, and any known melt-kneading method may be used. When the resin is a resin other than a thermoplastic resin, a known method of uniformly mixing each component may be used.

The method of manufacturing the flame-retardant resin composition of the present invention by the melt-kneading method is described below. By using this manufacturing method, the average primary particle diameter of the polysaccharide contained in the flame-retardant resin composition may be adjusted within the aforementioned suitable range. In particular, many natural polysaccharides have relatively large particle diameters, but by using this manufacturing method, the particle diameters of even natural polysaccharides may be made relatively small.

The manufacturing method preferably includes the following process. However, the pretreatment process may or may not be required.

### Process of Dry-Milling Polysaccharides (Pretreatment)

The number of melt-kneading steps may be reduced by dry-milling the polysaccharides in advance to reduce the particle size before mixing them with other materials.

Dry-milling methods are not restricted, and examples of milling machines that may be used include mortar, ball mill, pot mill, grinder, cutter mill, homogenizer, multi-bead shocker, pin mill, jet mill, hybridizer, extruder, and mass colloider. The milling time and processing pressure are preferably adjusted according to the type of polysaccharide and particle size.

In terms of excellent dispersibility in the flame-retardant resin composition, dry-milling using a ball mill, pot mill, grinder or multi-bead shocker is especially preferred.

### Process of Melt-Kneading Thermoplastic Resin and Polysaccharides

As a melt-kneading method, for example, a thermoplastic resin and a polysaccharide are premixed using various mixers such as a tumbler or a high-speed mixer known as a Henschel mixer. Then melt-kneading the premixed mixture with a kneading device such as a Banbury mixer, a roll, a plastograph, a single-screw extruder, a twin-screw extruder, or a kneader.

Among these methods, the use of an extruder is preferred from the viewpoint of production efficiency, and the use of a twin-screw extruder is more preferred. After the material is melt-kneaded using an extruder and the kneaded material is extruded into strands, the kneaded material may be processed into pellets, flakes, or other shapes.

It is preferable to thoroughly dry each material prior to pre-mixing the materials. The drying temperature is not particularly restricted and it is preferably in the range of 60 to 120° C. The drying time is not particularly restricted and it is preferably in the range of 2 to 6 hours. From the viewpoint that drying progresses more easily, drying under reduced pressure is preferred. The above drying may be performed after pre-mixing.

The temperature for melt-kneading is not particularly restricted and is preferably selected according to the type of resin used. Specifically, the temperature is preferably in the range of 150 to 280° C. Here, the temperature of melt-kneading corresponds to the cylinder temperature in a kneading device such as a twin-screw extruder, for example. The “cylinder temperature” refers to the temperature of the highest cylinder section in the cylinder of the kneading device when multiple temperature settings are made. The kneading pressure is not particularly limited and it is preferably in the range of 1 to 20 MPa.

The discharge rate from the kneading device is not particularly limited, and from the viewpoint of adequate melt-kneading, it is preferred to be in the range of 10 to 100 kg/hr, and more preferably in the range of 20 to 70 kg/hr.

In the above method, it is preferable that the melted and kneaded compound is cooled after being extruded from the kneading device. The method of cooling treatment is not particularly limited, and examples thereof include immersing the kneaded product in water in the range of 0 to 60° C. for water cooling, cooling with gas in the range of -40 to 60° C., and contacting with a metal in the range of -40 to 60° C.

The form and shape of the flame-retardant resin composition of the present invention are not particularly restricted and may be in solid form, such as powder, granule, tablet (tablet), pellet, flake, fiber, or liquid form.

The average primary particle diameter of the polysaccharide contained in the flame-retardant resin composition may be made smaller by performing melt-kneading multiple times. When melt-kneading is performed multiple times, the kneaded material is cooled and then melt-kneaded again in a kneading device. The number of melt-kneading cycles is preferably adjusted according to the type of polysaccharide and particle size.

### [Flame-Retardant Resin Molded Product]

The flame-retardant resin molded product of the present invention is characterized in that it is formed using the flame-retardant resin composition described above. The flame-retardant resin molded product of the present invention is formed using the aforementioned flame-retardant resin composition, thereby improving flame-retardancy and impact resistance.

When the resin is a thermoplastic resin, the flame-retardant resin molded product is obtained by melting and forming the aforementioned flame-retardant resin composition in various molding machines. The molding method may be selected according to the form and application of the molded product. Examples include injection molding, extrusion molding, compression molding, blow molding, calender molding, and inflation molding. Secondary molding such as vacuum molding or pressure molding may be performed on the sheet or film-like molded product obtained by extrusion molding or calendaring.

When the resin is a curable resin other than a thermoplastic resin, the aforementioned flame-retardant resin composition is cured to obtain a molded product. As for curing method, conventional methods of curing may be used.

Flame retardant-resin molded products are not particularly restricted and include, for example, parts in the fields of home appliances and automobiles (electrical and electronic parts, electrical components, exterior parts, and interior parts, various packaging materials, household goods, office supplies, plumbing, and agricultural materials.

### Flame-Retardant Resin Housing

The flame-retardant resin housing of the present invention is characterized in that it includes the aforementioned flame-retardant resin molded product. The flame-retardant resin composition of the present invention may improve flame-retardancy and impact resistance, and furthermore, because of its excellent appearance, it is preferable to mold it into an appropriate form and shape and use it as an enclosure. The flame-retardant resin housing of the present invention may be composed only of the aforementioned flame-retardant resin molded product, or it may be a configuration that partially includes the above-mentioned flame-retardant resin molded product.

Although there are no particular restrictions on the articles to be housed by the flame-retardant resin housing of the present invention, it is preferred to house electronic equipment. In addition, the flame-retardant resin housing of the present invention may also be applied to other enclosures that are generally preferred to be manufactured from flame-retardant resin.

In the present invention, “electronic equipment” refers to electrical products that apply electronics technology. Electronic equipment is not restricted, and includes, for example, computers, scanners, copiers, printers, facsimile machines, OA equipment such as multifunctional machines called MFP (Multi Function Peripheral) that combine these functions, and digital printing systems for commercial printing.

The flame-retardant resin housing of the present invention has excellent flame-retardancy and impact resistance, so that even if the electronic equipment inside is damaged by an external impact and ignites, it may be made difficult for the fire to spread and the risk of fire may be reduced.

Examples of the flame-retardant resin housing of the present invention are shown below. The figure is a schematic diagram of a large-size photocopier 10 housed in a flame-retardant resin housing of the present invention. The flame-retardant resin enclosure includes flame-retardant resin molded parts as exterior components G1 to G9.

### EXAMPLES

The present invention will be specifically described with examples below, but the invention is not limited to these examples. In the examples, “part” or “%” is used to indicate “part by mass” or “mass%” unless otherwise noted. In the following examples, all operations were performed at room temperature (25° C.) unless otherwise noted.

### Preparation of Flame-Retardant Resin Composition

The following resins and polysaccharides were prepared as the constituent materials of the flame-retardant resin composition.

### (Resin)

ABS1 (ABS resin): “TOYOLAC (registered trademark) 700-314”, made by Toray Industries, Inc.
ABS2 (ABS resin): “SANTAC (registered trademark) AT-05”, made by A & L Japan, Ltd.
PS (polystyrene): “TOYOSTYROL (registered trademark) HI H450 K9-020”, made by Toyo Styrene Co.
PP (polypropylene): “Prime Polypro (registered trademark) J715MJ”, made by Prime Polymer Co., Ltd.
PC (polycarbonate resin): “TUFLON (registered trademark) A190”, made by Idemitsu Kosan Co., Ltd.
PMMA (polymethyl methacrylate): ACRYPET (registered trademark) VRS40 0001″, made by Mitsubishi Chemical Corporation
PP (polypropylene) was a crystalline resin, and the other resins were amorphous resins.

### (Polysaccharide)

Chitin: made by Tokyo Kasei Kogyo Co., Ltd.
Chitosan: Chitosan (5 to 20 mPa·s, 0.5%/0.5% acetic acid solution/20° C.), made by Tokyo Kasei Kogyo Co. Ltd.
Cellulose: Cellulose, powder, 38 µm (400 mesh) pass, made by Fujifilm Wako Pure Chemicals Co.
A4 (sodium chondroitin sulfate): made by Tokyo Chemical Industry Co., Ltd.

### (Pretreatment of Polysaccharide)

In the flame-retardant resin compositions 1 to 3, 5 to 9, 11 to 22, and 24, the polysaccharides were pretreated by dry-milling in a ball mill in advance. For dry-milling, put 300 parts by mass of alumina balls (10 mm in diameter) into a pot with a diameter of 180 mm with respect to 50 parts by mass of particulate polysaccharide. Then, pulverization was performed with a ball mill (desktop pot mill mount “PM-002”, manufactured by AS ONE Corporation).
Rotation speed: 100 rpm
Time: Pretreatment time [hr] as shown in Table I

### (Preparation of Flame-Retardant Resin Composition)

As pre-drying before kneading, a resin and a polysaccharide each were dried at 80° C. for 4 hours. Then, they were weighed in the component ratios [mass%] shown in Table I and dry blended. The dry-blended mixture was then fed at a rate of 10 kg per hour from the feed port (hopper) of a twin-screw extruder “KTX-30” (made by Kobe Steel, Ltd.), and melt-kneading was performed at the cylinder temperature and screw speed of 200 rpm as shown in Table I. After kneading, the molten resin was cooled in a water bath at 30° C. and pelletized in a pelletizer to obtain a flame-retardant resin composition.

In Table I, for those melt-kneading counts of 2 or more times (2 or 3 times), the pelletized flame-retardant resin composition was fed again from the feed port of the twin-screw extruder, and further melt-kneaded once or twice under the above conditions.

The crystallization temperature of the flame-retardant resin composition finally obtained was measured by the following method. A differential scanning calorimeter (DSC) “DSC Pyris1” (made by Perkin Elmer Japan) or “DSC7020” (made by Hitachi High-Tech Science Corporation) was used, and under a nitrogen atmosphere (20 mL/min), the sample (about 5 mg) was heated to the attained temperature set for each resin (cylinder temperature listed in Table I), held at that temperature for 3 minutes, cooled to 30° C. at 10° C./minute, held at 30° C. for 1 minute, raised to the above attained temperature at 10° C./minute, and the crystallization temperature (Tc) was calculated from the peak top of the crystallization peak during the temperature decrease process.

In flame-retardant resin compositions 11 and 12, the crystallization temperature was measured in the region lower than the cylinder setting temperature listed in Table I. In other flame-retardant resin compositions, no crystallization temperature was measured.

The average primary particle size of the polysaccharides in the flame-retardant resin compositions was measured by the following method. A scanning electron microscope (SEM) (manufactured by JEOL Ltd.) was used to take a magnified image of the flame-retardant resin composition at 1,000 times magnification, and the image was imported into a computer using a scanner. The SEM image was then binarized by the automatic image processing and analysis system “LUZEX (registered trademark) AP” (Nireco Corporation) using software Ver. 1.3.2. The diameter of 300 randomly selected polysaccharide particles was calculated as the horizontal Feret diameter, and the average value was used as the average primary particle diameter. The average value was taken as the mean primary particle diameter. The “horizontal Feret diameter” refers to the length of the side parallel to the x-axis of the bounding rectangle of the binarized image of the polysaccharide particles.

### Evaluation

The following evaluations were conducted on each of the flame-retardant resin compositions obtained above.

### (Evaluation 1: Appearance of Exterior Component)

After drying each of the flame-retardant resin compositions in pellet form obtained above at 80° C. for 5 hours in a hot-air circulating dryer, a simulated molded product was prepared by using an injection molding machine “J1300E-C5” (manufactured by Japan Steel Works, Ltd.), assuming the exterior component G8 of the large-size copier shown in the figure, was molded at the cylinder setting temperature and mold temperature of 50° C. as shown in Table I. A sample was taken from the center of the simulated molded part.

The obtained samples were visually observed for appearance, and if appearance defects were found, the mold was modified and the molding conditions (cooling time) were changed to see if the appearance defects may be improved, using the following criteria. The ranks of “Triangle”, “Circle”, and “Double circle” were considered acceptable, indicating to have no problem in practical use.

“Double circle”: Molded product without appearance defects is obtained and no mold modification is required.

“Circle”: Molded product without appearance defects is obtained by only modifying the mold.

“Triangle”: Molded product without appearance defects is obtained by modifying the mold and changing the molding conditions.

“Cross mark”: No improvement in appearance defects (severe warpage) is obtained by modifying the mold or changing the molding conditions.

### (Evaluation 2: Flame-Retardancy)

Each of the flame-retardant resin compositions in pellet form obtained above was dried at 80° C. for 4 hours and then molded using an injection molding machine “J55ELII” (made by Japan Steel Works, Ltd.) at the cylinder temperature and mold temperature of 50° C. as described in Table I to obtain strip-type test pieces 125 mm long, 13 mm wide and 1.6 mm thick.

The obtained specimens were then humidified for 48 hours in a thermostatic chamber at 23° C. and 50% humidity, and tested for flame-retardancy in accordance with the UL94 test (combustion test for plastic materials for equipment parts) specified by Underwriters Laboratories (UL) of the United States. The UL94V test was conducted first, and those that did not meet the criteria of V-2 were further subjected to the UL94HB test and evaluated according to the following criteria. When the evaluation result was ranked “Triangle”, “Circle” or “Double circle”, it was determined to have no problem in practical use, and pass the test.

“Double circle”: Corresponds to V-0 in the UL94V test.

“Circle”: Corresponds to V-1 or V-2 in the UL94V test.

“Triangle”: Does not meet the criteria of V-2 in the UL94V test, but meets the criteria in the UL94HB test.

“Cross mark”: Does not meet the criteria of V-2 in the UL94V test, and does not meet the criteria in the UL94HB test.

### (Evaluation 3: Impact Resistance (Impact Strength))

Each of the flame-resistant resin composites in pellet form obtained above was dried at 80° C. for 4 hours, and then molded using the J55ELII injection molding machine (made by Japan Steel Works, Ltd.) at the cylinder temperature and mold temperature of 50° C. as shown in Table I. The mold was 80 mm long, 10 mm wide, and 4.0 mm thick. A strip-type test piece of 80 mm in length, 10 mm in width, and 4.0 mm in thickness was obtained. After 300 shots were discarded, 100 consecutive shots were used as the test specimens. The obtained 100 specimens were measured for Izod impact strength in accordance with JIS K7110:1999, and evaluated according to the following criteria. The ranks of “Double circle” and “Circle” were evaluated to have no problem in practical use and pass the test.
“Double circle”: 10 kJ/m² or more.
“Circle”: 7 kJ/m² or more and less than 10 kJ/m²
“Triangle”: 4 kJ/m² or more and less than 7 kJ/m²
“Cross mark”: Less than 4 kJ/m².

Table I shows the composition of each of the flame-retardant resin compositions obtained above and their evaluation results. The symbol “-” in the pretreatment time in the table indicates that no pretreatment was performed.

TABLE I

| Flame-retardant resin composition No. | Composition | | | | | Production condition | | |
|---|---|---|---|---|---|---|---|---|
| | Resin | | | Polysaccharide | | Pretreatment [hr] | Kneading time [Time] | Cylinder temperature [°C] |
| | Type | | Content [mass%] | Type | Content [mass%] | | | |
| 1 | ABS1 | Amorphous | 70 | Chitin | 30 | 24 | 2 | 195 |
| 2 | ABS1 | Amorphous | 70 | Chitin | 30 | 12 | 3 | 195 |
| 3 | ABS1 | Amorphous | 70 | Chitin | 30 | 24 | 3 | 195 |
| 4 | ABS2 | Amorphous | 70 | Chitin | 30 | - | 3 | 195 |
| 5 | PS | Amorphous | 70 | Chitin | 30 | 30 | 2 | 200 |
| 6 | ABS1 | Amorphous | 70 | Chitosan | 30 | 24 | 1 | 195 |
| 7 | PS | Amorphous | 60 | Chitosan | 40 | 24 | 1 | 200 |
| 8 | ABS2 | Amorphous | 80 | Chitosan | 20 | 24 | 1 | 195 |
| 9 | ABS2 | Amorphous | 60 | Chitosan | 40 | 24 | 1 | 195 |
| 10 | ABS1 | Amorphous | 70 | Chitin | 30 | - | 1 | 195 |
| 11 | PP | Crystalline | 70 | Chitin | 30 | 60 | 2 | 180 |
| 12 | PP | Crystalline | 80 | Chitosan | 20 | 24 | 1 | 180 |
| 13 | ABS1 | Amorphous | 70 | A4 | 30 | 24 | 1 | 195 |
| 14 | PC | Amorphous | 70 | Chitin | 30 | 24 | 1 | 265 |
| 15 | PMMA | Amorphous | 70 | Chitin | 30 | 24 | 1 | 200 |
| 16 | ABS1 | Amorphous | 70 | Chitin | 30 | 60 | 3 | 195 |
| 17 | ABS1 | Amorphous | 70 | Chitin | 30 | 48 | 3 | 195 |
| 18 | ABS1 | Amorphous | 70 | Chitin | 30 | 24 | 1 | 195 |
| 19 | ABS1 | Amorphous | 97 | Chitin | 3 | 24 | 2 | 195 |
| 20 | ABS1 | Amorphous | 95 | Chitin | 5 | 24 | 2 | 195 |
| 21 | ABS1 | Amorphous | 50 | Chitin | 50 | 24 | 2 | 195 |
| 22 | ABS1 | Amorphous | 60 | Chitin | 40 | 24 | 2 | 195 |
| 23 | ABS1 | Amorphous | 70 | Cellulose | 30 | - | 1 | 195 |
| 24 | ABS1 | Amorphous | 70 | Cellulose | 30 | 24 | 2 | 195 |

TABLE I Continued

| Flame-retardant-resin composition No. | Polysaccharide particle diameter [µ m] | Evaluation | | | Remarks |
|---|---|---|---|---|---|
| | | Appearance of exterior component | Flame-retardancy | Impact resistance | |
| 1 | 250.00 | ⊚ | O | Δ | Present Invention |
| 2 | 80.00 | O | O | O | Present Invention |
| 3 | 30.00 | ⊚ | ⊚ | ○ | Present Invention |
| 4 | 2.00 | ⊚ | ⊚ | ⊚ | Present Invention |
| 5 | 0.50 | ⊚ | Δ | ○ | Present Invention |
| 6 | 70.00 | ○ | ○ | ○ | Present Invention |
| 7 | 70.00 | ○ | ○ | ○ | Present Invention |
| 8 | 70.00 | ⊚ | Δ | ⊚ | Present Invention |
| 9 | 70.00 | ○ | Δ | ⊚ | Present Invention |
| 10 | 400.00 | Δ | Δ | Δ | Present Invention |
| 11 | 3.00 | ○ | Δ | Δ | Present Invention |
| 12 | 70.00 | Δ | Δ | Δ | Present Invention |
| 13 | 150.00 | Δ | ○ | Δ | Present Invention |
| 14 | 250.00 | ○ | Δ | ○ | Present Invention |
| 15 | 250.00 | ○ | Δ | Δ | Present Invention |
| 16 | 0.06 | ○ | Δ | Δ | Present Invention |
| 17 | 0.10 | ⊚ | ⊚ | ○ | Present Invention |
| 18 | 300.00 | ○ | ○ | Δ | Present Invention |
| 19 | 250.00 | ○ | Δ | ⊚ | Present Invention |
| 20 | 250.00 | ○ | ○ | ○ | Present Invention |
| 21 | 250.00 | Δ | ○ | Δ | Present Invention |
| 22 | 250.00 | ○ | ○ | Δ | Present Invention |
| 23 | 28.00 | Δ | × | × | Comparative Example |
| 24 | 2.00 | ○ | × | × | Comparative Example |

From the comparison of the flame-retardant resin compositions 1 to 22 (the present invention) and 23 and 24 (comparative examples), it can be seen that the effect of the present invention is manifested when the sugar backbone in the polysaccharide has at least a basic functional group or a salt of a basic functional group. From the flame-retardant resin compositions 1 to 22, it can also be observed that the effect of the present invention is manifested when the basic functional group is an amino group or a substituted amino group.

From the comparison of flame-retardant resin compositions 1 and 6 and 13, it can be observed that the appearance and impact resistance are further improved when the sugar backbone having an amino group or substituted amino group is a glucosamine backbone or an N-acetylglucosamine backbone, respectively. The appearance and impact resistance are further improved when the polysaccharide is chitosan or chitin, respectively.

From the flame-retardant resin compositions 1 to 22, it can be seen that when the resin is a thermoplastic resin, handling is facilitated and the effect of the present invention is exhibited. From the comparison of flame-retardant resin compositions 8 and 12, it can be seen that the appearance and impact resistance are further improved when the thermoplastic resin is an amorphous resin.

From the comparison of flame-retardant resin compositions 1 to 5, 14 and 15 and 11, it can be seen that the appearance, flame-retardancy and impact resistance are further improved when the thermoplastic resin contains at least one of an ABS resin, polystyrene, polymethyl methacrylate or polycarbonate.

From the comparison of flame-retardant resin compositions 1 to 3, 17 and 18 with 10 and 16, it is shownthat the appearance, flame-retardancy and impact resistance are further improved when the average primary particle diameter of the polysaccharide is in the range of 0.1 to 300 µm.

From the comparison of flame-retardant resin compositions 1, 20 and 22 with 19 and 21, it is shown that appearance and flame-retardancy are improved when the polysaccharide content is within the range of 5 to 40 mass% relative to the total mass of the flame-retardant resin compositions.

In addition, in the manufacturing method of the flame-retardant resin composition, by having a step of dry-milling the polysaccharide and a step of melt-kneading the thermoplastic resin and the polysaccharide, or having a step of melt-kneading the thermoplastic resin and the polysaccharide, and the number of melt-kneading is 2 or more, it can be seen that flame-retardancy and impact resistance are improved.

Although embodiments of the present invention have been described and illustrated in detail, the disclosed embodiments are made for purposes of illustration and example only and not limitation. The scope of the present invention should be interpreted by terms of the appended claims.

Reference Signs List

| | | |
|---|---|---|
| 10: | Large-size copier | |
| G1 to G9: | | Exterior component |

1. A flame-retardant resin composition comprising a resin and a polysaccharide, wherein a sugar backbone in the polysaccharide has at least a basic functional group or a salt of the basic functional group.

2. The flame-retardant resin composition according to claim 1, wherein the basic functional group is an amino group or a substituted amino group.

3. The flame-retardant resin composition according to claim 2, wherein the sugar backbone having an amino group or a substituted amino group is a glucosamine backbone or an N-acetylglucosamine backbone, respectively.

4. The flame-retardant resin composition according to claim 3, wherein the polysaccharide is chitosan or chitin.

5. The flame-retardant resin composition according to claim 1, wherein the resin is a thermoplastic resin.

6. The flame-retardant resin composition according to claim 5, wherein the thermoplastic resin is an amorphous resin.

7. The flame-retardant resin composition according to claim 5, wherein the thermoplastic resin contains at least one of an ABS resin, polystyrene, polymethyl methacrylate or polycarbonate.

8. The flame-retardant resin composition according to claim 1, wherein the polysaccharide is dispersed in a particle state and has an average primary particle diameter in the range of 0.10 to 300.0 µm.

9. The flame-retardant resin composition according to claim 1, wherein a content of the polysaccharide is in the range of 5 to 40 mass% relative to the total mass of the flame-retardant resin composition.

10. A method for producing the flame-retardant resin composition according to claim 5, comprising the steps of dry-milling the polysaccharide, and melt-kneading the thermoplastic resin and the polysaccharide.

11. The method for producing the flame-retardant resin composition according to claim 5, comprising the step of melt-kneading the thermoplastic resin and the polysaccharide, wherein the melt-kneading is performed two or more times.

12. A flame-retardant resin molded product formed by using the flame-retardant resin composition according to claim 1.

13. A flame-retardant resin housing including the flame-retardant resin molded product according to claim 12.
